(19) United States
(12) Patent Application Publication
(10) Pub. No.: US 2007/0278948 A1
(43) Pub. Date: Dec. 6, 2007

(54) Manufacturing method of light-emitting material, light-emitting element, and light-emitting device and electronic device

(75) Inventors: Junichiro Sakata, Atsugi (JP); Miki Katayama, Atsugi (JP)

Correspondence Address: COOK, ALEX, McFARRON, MANZO;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 11/807,578

(22) Filed: May 29, 2007

(30) Foreign Application Priority Data
Jun. 2, 2006 (JP) 2006-155280

(51) Int. Cl. H01J 1/62; H01J 63/04

(52) U.S. Cl. 313/506

(57) ABSTRACT

An object of the present invention is to provide a manufacturing method of a light-emitting material having high purity. In addition, another object thereof is to provide a light-emitting element having high luminance. Moreover, still another object thereof is to provide a light-emitting device and an electronic device each having high luminance. The present invention provides a method for manufacturing a light-emitting material including the steps of: forming a first layer containing a luminescence center element in a container; forming a second layer containing a host material in the container so as to cover the first layer; and performing heat treatment to the first layer and the second layer in the container, whereby the second layer is doped with the luminescence center element.

### BACKGROUND OF THE INVENTION

1. Field of the Invention

The present invention relates to a manufacturing method of a light-emitting material. In addition, the present invention relates to a light-emitting element utilizing electroluminescence. Moreover, the present invention relates to a light-emitting device and an electronic device each having a light-emitting element.

2. Description of the Related Art

In recent years, thin and flat display devices have been needed as display devices used for televisions, cellular phones, digital cameras, and the like. As the display devices satisfying this need, display devices using self-light-emitting elements have attracted attention. One of the self-light-emitting elements is a light-emitting element utilizing electroluminescence (EL), and this light-emitting element includes a light-emitting material interposed between a pair of electrodes and can provide emission from the light-emitting material by voltage application.

Such a self-light-emitting element has advantages over a liquid crystal display element, such as high visibility of the pixels and no need of backlight, and the self-light-emitting element is considered suitable as a flat panel display element. Another major advantage of such a light-emitting element is that it can be manufactured to be thin and lightweight. In addition, extremely high response speed is also a feature.

Further, such a self-light-emitting element can be formed into a film shape; therefore, a large-area element is formed so that plane emission can be easily obtained. Since this feature is hard to obtain from a point light source typified by an incandescent lamp or an LED or a linear light source typified by a fluorescent lamp, the self-light-emitting element has high utility as a plane light source which is applicable to a lighting system or the like.

Light-emitting elements with the utilization of electroluminescence are classified in accordance with whether a light-emitting material is an organic compound or an inorganic compound. In general, the former is referred to as an organic EL element, and the latter as an inorganic EL element.

Inorganic EL elements are classified in accordance with their element structures into dispersion-type inorganic EL elements and thin-film inorganic EL elements. They differ in that the former includes a light-emitting layer where particles of a light-emitting material are dispersed in a binder, and the latter includes a light-emitting layer formed of a thin film of a light-emitting material; however, they are share a common feature in that both require electrons accelerated by a high electric field. Note that a mechanism of emission includes a donor-acceptor recombination-type light emission which utilizes a donor level and an acceptor level and a localized-type light emission which utilizes inner-shell electron transition of metal ions. In general, in many cases, dispersion-type inorganic EL elements employ donor-acceptor recombination-type light emission, and thin-film inorganic EL elements employ localized-type light emission.

The light-emitting material used for such an inorganic EL element is a material where a host material such as zinc sulfide is doped with a luminescence center element such as manganese or copper. There are, for example, Patent Document 1: Japanese Published Patent Application No. 2004-99881 and Patent Document 2: Japanese Published Patent Application No. 2004-244636 as a manufacturing method thereof and a manufacturing method of a light-emitting material having white light emission, respectively. In these manufacturing methods, a host material and a material including a luminescence center element are mixed and baked so as to manufacture the light-emitting material. However, there have been problems that it is difficult to control the concentration of the material including a luminescence center element, a large number of by-products are generated when the concentration is high, and the purity of the light-emitting material gets low.

### SUMMARY OF THE INVENTION

In view of the above problems, an object of the present invention is to provide a manufacturing method of a light-emitting material having high purity. In addition, another object thereof is to provide a light-emitting element having high luminance. Moreover, still another object thereof is to provide a light-emitting device and an electronic device each having high luminance.

According to one feature of the present invention, a method for manufacturing a light-emitting material includes the steps of: forming a first layer containing a luminescence center element in a container; forming a second layer containing a host material in the container so as to cover the first layer; and performing heat treatment to the first layer and the second layer in the container, whereby the second layer is doped with the luminescence center element.

In the above structure, the heat treatment is preferably performed at a temperature greater than or equal to 700° C. and less than or equal to 1500° C. In addition, the heat treatment is preferably performed under a sulfide gas atmosphere.

In addition, in the above structure, the luminescence center element is preferably one or more selected from copper, silver, gold, manganese, terbium, europium, thulium, cerium, praseodymium, samarium, erbium, aluminum, chlorine, or fluorine.

Moreover, in the above structure, the host material is preferably any one selected from zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium-aluminum sulfide, calcium-gallium sulfide, strontium-gallium sulfide, or barium-gallium sulfide.

Further, in the above structure, the second layer may further contain a luminescence center element different from the luminescence center element contained in the first layer. In particular, a light-emission color from the luminescence center element contained in the first layer and a light-emission color from the luminescence center element contained in the second layer are in a relation of a complementary color, whereby a light-emitting element which emits white light can be obtained.

According to another feature of the present invention, a light-emitting element includes a light-emitting layer between a pair of electrodes, where the light-emitting layer has a light-emitting material in particles which is dispersed in a binder, where the light-emitting material contains a first luminescence center element and a host material, and where the concentrations of the first luminescence center element contained in each of the particles which are dispersed in the binder are different per particle.

In the above structure, an insulating layer may further included between the pair of electrodes. The insulating layer includes preferably one or more selected from yttrium oxide, titanium oxide, aluminum oxide, hafnium oxide, tantalum oxide, silicon oxide, barium titanate, strontium titanate, lead titanate, silicon nitride, or zirconium oxide.

In addition, in the above structure, the first luminescence center element is preferably any one selected from copper, silver, gold, manganese, terbium, europium, thulium, cerium, praseodymium, samarium, erbium, aluminum, chlorine, or fluorine.

Moreover, in the above structure, the light-emitting material may also contain a second luminescence center element. The second luminescence center element, which is preferably different from the first luminescence center element, is any one selected from copper, silver, gold, manganese, terbium, europium, thulium, cerium, praseodymium, samarium, erbium, aluminum, chlorine, or fluorine.

Further, in the above structure, the host material is preferably any one selected from zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium-aluminum sulfide, calcium-gallium sulfide, strontium-gallium sulfide, or barium-gallium sulfide.

In addition, the present invention includes in its scope a light-emitting device having the above light-emitting element. According to still another feature of the present invention, a light-emitting device includes the light-emitting element and a control means for controlling light emission of the light-emitting element. Note that the light-emitting device in this specification includes an image display device, a light-emitting device, or a light source (including a lighting system). Moreover, the light-emitting device includes all of the following modules: a module in which a connector such as an FPC (Flexible Printed Circuit), a TAB (Tape Automated Bonding) tape, or a TCP (Tape Carrier Package) is attached to a panel provided with light-emitting elements; a module having a TAB tape or a TCP provided with a printed wiring board at the end thereof; and a module having an IC (Integrated Circuit) directly mounted on a light-emitting element by a COG (Chip On Glass) method.

Moreover, the present invention also includes in its scope an electronic device using the light-emitting element of the present invention for a display portion. Therefore, according to the present invention, an electronic device thereof has a display portion, and the display portion is provided with the light-emitting element and a control means for controlling light emission of the light-emitting element.

A light-emitting material having high purity can be obtained by the manufacturing method of a light-emitting material according to the present invention.

In addition, a light-emitting element having high luminance can be obtained using a light-emitting material which is obtained by the manufacturing method of the present invention.

Moreover, since the light-emitting device of the present invention has light-emitting element having high luminance, high luminance can be obtained. In addition, a light-emitting device and an electronic device, where each of the power consumption is reduced, can be obtained.

### BRIEF DESCRIPTION OF DRAWINGS

FIG. 1 illustrates a manufacturing method of a light-emitting material of the present invention;

FIG. 2 illustrates a manufacturing method of a light-emitting material of the present invention;

FIG. 3 illustrates a manufacturing method of a light-emitting material of the present invention;

FIG. 4 illustrates a manufacturing method of a light-emitting material of the present invention;

FIG. 5 illustrates a light-emitting element of the present invention;

FIG. 6 illustrates a light-emitting device of the present invention;

FIG. 7 illustrates a light-emitting device of the present invention;

FIG. 8 illustrates a light-emitting device of the present invention;

FIGS. 9A and 9B illustrate a light-emitting device of the present invention;

FIGS. 10A and 10B illustrate a light-emitting device of the present invention;

FIGS. 11A and 11B illustrate a light-emitting device of the present invention;

FIGS. 12A to 12D each illustrate an electronic device of the present invention;

FIG. 13 illustrates a lighting system of the present invention;

FIGS. 14A to 14C each illustrate a lighting system of the present invention;

FIG. 15 illustrates a lighting system of the present invention;

FIG. 16 illustrates a lighting system of the present invention;

FIG. 17 illustrates a PL spectrum of a light-emitting material of the present invention; and

FIG. 18 illustrates a PL spectrum of a light-emitting material of the present invention.

### DETAILED DESCRIPTION OF THE INVENTION

Embodiment modes of the present invention will be explained hereinafter with reference to the accompanying drawings. However, it is to be easily understood that various changes and modifications will be apparent to those skilled in the art. Therefore, unless such changes and modifications depart from the purpose and the scope of the present invention, they should be construed as being included therein.

### Embodiment Mode 1

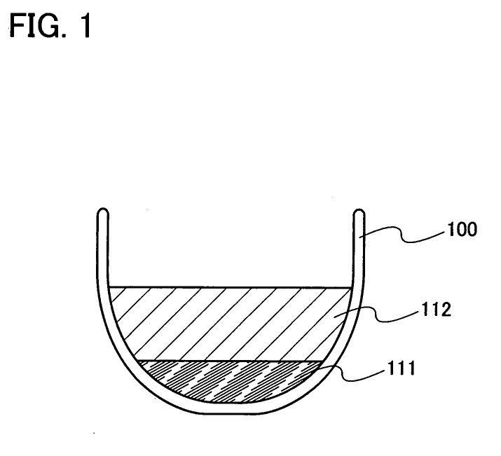

This embodiment mode will explain a manufacturing method of a light-emitting material according to the present invention with reference to FIG. 1. FIG. 1 is a cross-sectional view of a container 100 where a first layer 111 and a second layer 112 are stacked. This embodiment mode will explain below a manufacturing method of a light-emitting material which is obtained by performance of heat treatment to the container 100 in which materials in the container are baked.

First, the predetermined amount of a luminescence center material such as manganese is weighed to be contained in the container 100 so as to form the first layer 111. The predetermined amount of a host material such as zinc sulfide is weighed to be contained in the container 100 so as to form the second layer 112 over the first layer 111. Note that the materials may be planarized and contained with appropriate vibration applied thereto.

As a material of the container 100, a material such as quartz, alumina, or boron nitride can be used, which can be used in various shapes, for example, a hemispheric shape, a cylinder shape, or the like.

As a material for forming the first layer 111, a material containing a luminescence center element (hereinafter, referred to as a luminescence center material) can be used. As the luminescence center element, copper, silver, gold, manganese, terbium, europium, thulium, cerium, praseodymium, samarium, erbium), aluminum, chlorine, fluorine, or the like can be used and, as the luminescence center material, a single substance or a compound thereof can be used. When the luminescence center material is a compound, the following can be used: copper sulfide, copper chloride, copper fluoride, copper sulfate, silver sulfide, silver chloride, silver fluoride, manganese sulfide, manganese carbonate, terbium chloride, terbium fluoride, europium oxide, europium chloride, europium fluoride, thulium oxide, thulium fluoride, praseodymium chloride, praseodymium fluoride, samarium oxide, samarium chloride, samarium fluoride, cerium oxide, cerium chloride, cerium fluoride, erbium oxide, erbium chloride, erbium fluoride, aluminum sulfate, aluminum chloride, or the like.

As a material for forming the second layer 112, a host material can be used. As the host material, sulfide, oxide, or nitride can be used. As sulfide, for example, zinc sulfide, cadmium sulfide, calcium sulfide, yttrium sulfide, gallium sulfide, strontium sulfide, barium sulfide, or the like can be used. As oxide, for example, zinc oxide, yttrium oxide, or the like can be used. As nitride, for example aluminum nitride, gallium nitride, indium nitride, or the like can be used. Further, zinc selenide, zinc telluride, or the like can also be used, and a ternary mixed compound such as barium-aluminum sulfide, calcium-gallium sulfide, strontium-gallium sulfide, or barium-gallium sulfide may also be used.

Note that, after the luminescence center material is contained in the container 100 to form the first layer 111, heat treatment is performed, and the luminescence center material is melted, cooled, and solidified. Thereafter, the host material can also be contained in the container 100 so as to form the second layer 112.

Next, the container 100 is heated to bake the materials in the container. Baking may be performed under an atmosphere, a N₂ atmosphere, an Ar atmosphere, or a sulfide gas atmosphere. As the sulfide gas, for example, hydrogen sulfide, carbon disulfide, sulfur vapor, mercaptan such as ethyl mercaptan or methyl mercaptan, dimethyl sulfur, diethyl sulfur, or the like can be used. Most preferably, hydrogen sulfide gas is used. This is because hydrogen sulfide partially decomposes to generate sulfur and hydrogen; thus, sulfur deficiency in the light-emitting material is prevented, while at the same time, a hydrogen reduction effect can be anticipated. Alternatively, after the container is put in a quartz tube and exhaustion is performed so as to obtain a pressure of less than or equal to 1×10⁻³ Pa, the quartz tube can also be sealed and heated to bake the materials. Note that the baking temperature is preferably 700 to 1500° C.

A solid-phase reaction of the host material and the luminescence center material is generated by the baking; therefore, a light-emitting material where the host material is doped with the luminescence center material is obtained. In a general manufacturing method where a host material and a luminescence center material are mixed, a solid-phase reaction between luminescence center materials is generated as well as a solid-phase reaction of a host material and a luminescence center material, whereby a by-product such as an alloy is generated. In particular, a by-product is remarkably observed when a mixture ratio of a luminescence center material is high. It is considered that this is because an unreacted luminescence center material exists, though the solid solubility of a host material reaches a limit thereof when the solid-phase reaction is generated. In addition, generation of such a by-product results in purity decrease of the light-emitting material, and concentration quenching when the light-emitting material is used for a light-emitting element. On the other hand, a host material and a luminescence center material are separated in the manufacturing method in accordance with this embodiment mode. The luminescence center material, which becomes vapor by application of heat, is diffused in the host material; however, the luminescence center material, which becomes vapor, has a high diffusion coefficient; thus, the concentration of the luminescence center material does not partially increase. In addition, even when the luminescence center material is not vaporized, a solid-phase reaction continues in an interface between the host material and the luminescence center material, and the luminescence center material is diffused in the host material. However, a reaction of a by-product is unlikely to continue even when the host material reaches solid solubility thereof because an unreacted luminescence center material does not exist in the host material.

In the second layer 112 after the baking, a light-emitting material doped with the luminescence center material contained in the first layer 111 can be obtained. According to the manufacturing method of a light-emitting material in accordance with this embodiment mode, a light-emitting material having concentration distribution of the luminescence center material or a homogeneous light-emitting material can be obtained under a condition in which only a temperature and time are set, and the amount of the luminescence center material does not need to be adjusted. Note that, in a case of a light-emitting material having concentration distribution of the luminescence center material, the obtained light-emitting material is ground, stirred, and baked again, whereby a homogeneous light-emitting material can be obtained, as well. In addition, since the host material and the luminescence center material are separated, a by-product is unlikely generated; thus, a light-emitting material having high purity can be obtained.

### Embodiment Mode 2

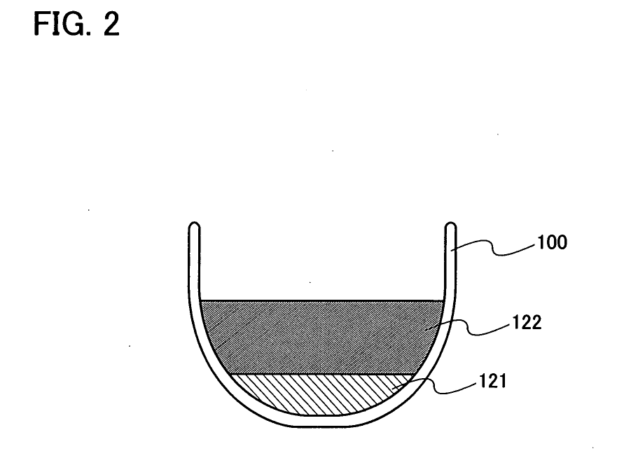

This embodiment mode will explain a manufacturing method of a light-emitting material according to the present invention with reference to FIG. 2. FIG. 2 is a cross-sectional view of a container 100 where a first layer 121 and a second layer 122 are stacked. This embodiment mode will explain below a manufacturing method of a light-emitting material which is obtained by performance of heat treatment to the container 100 in which materials in the container are baked.

First, the predetermined amount of a luminescence center material such as manganese is weighed to be contained in the container 100 so as to form the first layer 121. The predetermined amount of a host material such as zinc sulfide is weighed to be contained in the container 100 so as to form the second layer 122 over the first layer 121. Note that the materials may be planarized and contained with appropriate vibration applied thereto.

As a host material for forming the second layer 122, any of the materials explained in Embodiment Mode 1 can be used. The luminescence center material for forming the first layer 121 is a mixture of two or more of different luminescence center materials. As the luminescence center material, any of the materials explained in Embodiment Mode 1 can be used, and a mixture of a single substance or a compound of the materials can be used. For example, when Mn and Th are doped as the luminescence center element, MnS and TbF₃ are each weighed so that a mixture thereof can be formed as the first layer 121. Note that the first layer 121 can also be formed by the stack of luminescence center materials, instead of the mixture.

Next, the container 100 is heated to bake the materials in the container. Baking may be performed under an atmosphere, a N₂ atmosphere, an Ar atmosphere, or a sulfide gas atmosphere. As the sulfide gas, for example, hydrogen sulfide, carbon disulfide, sulfur vapor, mercaptan such as ethyl mercaptan or methyl mercaptan, dimethyl sulfur, diethyl sulfur, or the like can be used. Most preferably, hydrogen sulfide gas is used. This is because hydrogen sulfide partially decomposes and sulfur and hydrogen are generated; thus, sulfur deficiency in the light-emitting material is prevented, while at the same time, a hydrogen reduction effect can be anticipated. Alternatively, after the container is put in a quartz tube and exhaustion is performed so as to obtain a pressure of less than or equal to 1×10⁻³ Pa, the quartz tube can also be sealed and used to bake the materials. Note that the baking temperature is preferably 700 to 1500° C.

After the baking, a light-emitting material doped with a plurality of luminescence center materials is obtained in the second layer 122. According to the manufacturing method of a light-emitting material in accordance with this embodiment mode, a light-emitting material having a plurality of wavelength peaks can be obtained under a condition in which only a temperature and time are set, and the amount of the luminescence center materials does not need to be adjusted. Therefore, white light emission can also be obtained easily. Note that, in a case of a light-emitting material having concentration distribution of the luminescence center materials, the obtained light-emitting material is ground, stirred, and baked again, whereby a homogeneous light-emitting material can be obtained, as well. In addition, since the host material and the luminescence center materials are separated, a by-product is unlikely generated; thus, a light-emitting material having high purity can be obtained.

Note that this embodiment mode can appropriately be combined with other embodiment modes.

### Embodiment Mode 3

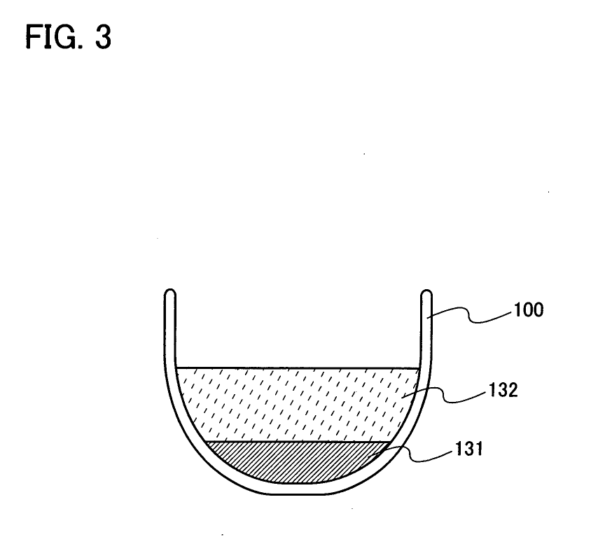

This embodiment mode will explain a manufacturing method of a light-emitting material according to the present invention with reference to FIG. 3. FIG. 3 is a cross-sectional view of a container 100 where a first layer 131 and a second layer 132 are stacked. This embodiment mode will explain below a manufacturing method of a light-emitting material which is obtained by performance of heat treatment to the container 100 in which materials in the container are baked.

First, the predetermined amount of a luminescence center material such as manganese is weighed to be contained in the container 100 so as to form the first layer 131. The predetermined amount of a host material is weighed to be contained in the container 100 so as to form the second layer 132 over the first layer 131. Note that the materials may be planarized and contained with appropriate vibration applied thereto.

As the container 100 and the luminescence center material for forming the first layer 131, any of the materials explained in Embodiment Mode 1 can be used. The light-emitting material is used as the host material of the second layer 132. As the light-emitting material used in this embodiment mode, any of the light-emitting materials manufactured in Embodiment Modes 1 and 2 can be used. Further, a light-emitting material, which is synthesized utilizing a general solid-phase reaction, can also be used. For example, ZnS doped with Mn (ZnS: Mn), ZnS doped with Th (ZnS: Th), ZnS doped with Cu and Cl (ZnS: Cu, Cl), or the like can be used.

Next, the container 100 is heated to bake the materials in the container. Baking may be performed under an atmosphere, a N₂ atmosphere, an Ar atmosphere, or a sulfide gas atmosphere. As the sulfide gas, for example, hydrogen sulfide, carbon disulfide, sulfur vapor, mercaptan such as ethyl mercaptan or methyl mercaptan, dimethyl sulfur, diethyl sulfur, or the like can be used. Most preferably, hydrogen sulfide gas is used. This is because hydrogen sulfide partially decomposes and sulfur and hydrogen are generated; thus, sulfur deficiency in the light-emitting material is prevented, while at the same time, a hydrogen reduction effect can be anticipated. Alternatively, after the container is put in a quartz tube and exhaustion is performed so as to obtain a pressure of less than or equal to 1×10⁻³ Pa, the quartz tube can also be sealed and used to bake the materials. Note that the baking temperature is preferably 700 to 1500° C.

After the baking, a light-emitting material doped with a plurality of luminescence center materials is obtained in the second layer 132. According to the manufacturing method of a light-emitting material in accordance with this embodiment mode, a light-emitting material having a plurality of wavelength peaks can be obtained under a condition in which only a temperature and time are set, and the amount of the luminescence center materials does not need to be adjusted. Therefore, white light emission can also be obtained easily. Note that, in a case of a light-emitting material having concentration distribution of the luminescence center materials, the obtained light-emitting material is ground, stirred, and baked again, whereby a homogeneous light-emitting material can be obtained, as well. In addition, since the host material and the luminescence center materials are separated, a by-product is unlikely generated; thus, a light-emitting material having high purity can be obtained.

Note that this embodiment mode can appropriately be combined with other embodiment modes.

### Embodiment Mode 4

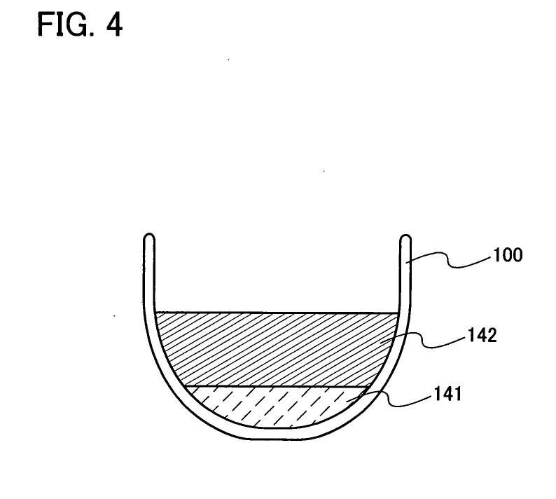

This embodiment mode will explain a manufacturing method of a light-emitting material according to the present invention with reference to FIG. 4. FIG. 4 is a cross-sectional view of a container 100 where a first layer 141 and a second layer 142 are stacked. This embodiment mode will explain below a manufacturing method of a light-emitting material which is obtained by performance of heat treatment to the container 100 in which materials in the container are baked.

First, the predetermined amount of a luminescence center material such as manganese is weighed to be contained in the container 100 so as to form the first layer 141. The predetermined amount of a host material is weighed to be contained in the container 100 so as to form the second layer 142 over the first layer 141. Note that the materials may be planarized and contained with appropriate vibration applied thereto.

The luminescence center materials for forming the first layer 141 is a mixture of luminescence center materials containing two or more of different luminescence center elements. As the luminescence center materials, any of the materials explained in Embodiment Mode 1 can be used, and a mixture of a single substance or a compound of the materials can be used. For example, when Mn and Th are doped as the luminescence center elements, MnS and TbF₃ are each weighed so that a mixture thereof can be used for the first layer 141. Note that the first layer 141 can also be formed by the stack of luminescence center materials, instead of the mixture. The light-emitting material is used as the host material of the second layer 142. As the light-emitting material used in this embodiment mode, any of the light-emitting materials manufactured in Embodiment Modes 1 and 2 can be used. Further, a general light-emitting material, which is synthesized utilizing a solid-phase reaction, can also be used. For example, ZnS doped with Mn (ZnS: Mn), ZnS doped with Th (ZnS: Th), ZnS doped with Cu and Cl (ZnS: Cu, Cl), or the like can be used.

Next, the container 100 is heated to bake the materials in the container. Baking may be performed under an atmosphere, a N₂ atmosphere, an Ar atmosphere, or a sulfide gas atmosphere. As the sulfide gas, for example, hydrogen sulfide, carbon disulfide, sulfur vapor, mercaptan such as ethyl mercaptan or methyl mercaptan, dimethyl sulfur, diethyl sulfur, or the like can be used. Most preferably, hydrogen sulfide gas is used. This is because hydrogen sulfide partially decomposes and sulfur and hydrogen are generated; thus, sulfur deficiency in the light-emitting material is prevented, while at the same time, a hydrogen reduction effect can be anticipated. Alternatively, after the container is put in a quartz tube and exhaustion is performed so as to obtain a pressure of less than or equal to 1×10⁻³ Pa, the quartz tube can also be sealed and used to bake the materials. Note that the baking temperature is preferably 700 to 1500° C.

After the baking, a light-emitting material doped with a plurality of luminescence center materials is obtained in the second layer 142. According to the manufacturing method of a light-emitting material in accordance with this embodiment mode, a light-emitting material having a plurality of wavelength peaks can be obtained under a condition in which only a temperature and time are set, and the amount of the luminescence center materials does not need to be adjusted. Therefore, white light emission can also be obtained easily. Note that, in a case of a light-emitting material having concentration distribution of the luminescence center materials, the obtained light-emitting material is ground, stirred, and baked again, whereby a homogeneous light-emitting material can be obtained, as well. In addition, since the host material and the luminescence center materials are separated, a by-product is unlikely generated; thus, a light-emitting material having high purity can be obtained.

Note that this embodiment mode can appropriately be combined with other embodiment modes.

### Embodiment Mode 5

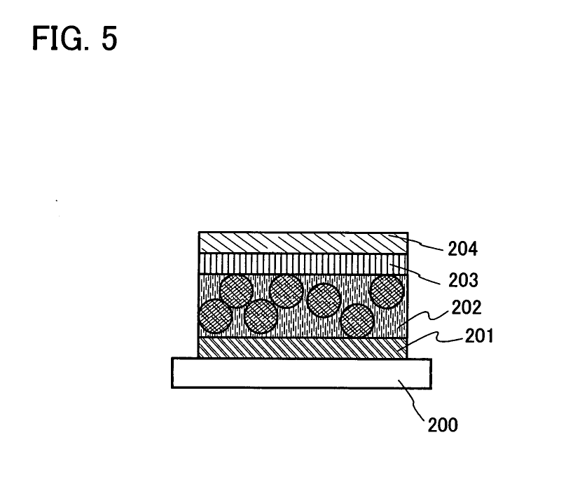

This embodiment mode will explain a dispersion-type light-emitting element according to the present invention with reference to FIG. 5.

The light-emitting element shown in this embodiment mode has an element structure where a first electrode 201, a second electrode 204, an insulating layer 203 in contact with the second electrode 204, and a light-emitting layer 202 between the first electrode 201 and the insulating layer 203 are provided over a substrate 200. The light-emitting element shown in this embodiment mode emits light from the light-emitting layer 202 by voltage application between the first electrode 201 and the second electrode 204, and can also be operated by either DC drive or AC drive. Note that, in this specification, an EL layer collectively refers to layers formed between a pair of electrodes.

The light-emitting layer 202 is a film where particles of any of the light-emitting materials shown in Embodiment Modes 1 to 4 are dispersed in a binder. The binder is a substance used for fixing the particles of the light-emitting material in a dispersed state and for keeping a shape as a light-emitting layer. The light-emitting material is evenly dispersed and fixed in the light-emitting layer by the binder. When particles having a desired size cannot be obtained depending on a manufacturing method of the light-emitting material, the light-emitting material may be crashed in a mortar or the like so as to be processed into particles having the desired size. In addition, when the light-emitting material manufactured using the manufacturing method of the present invention is processed in particle state, the concentrations of luminescence center element contained in each of the particles are different per particle. This is because, when the luminescence center element diffuses to a layer containing a host material by heat, in the layer containing the host material, the concentration of a luminescence center element which diffuses in a region near a layer containing the luminescence center element gets high, whereas the concentration of a luminescence center element which diffuses in a region far from the layer containing the luminescence center element gets low. Therefore, when the light-emitting material is processed in particle state, the concentrations of luminescence center element contained in each of the particles are different per particle. The rate of this concentration in each particle can be adjusted only by decision of a condition of a heating temperature and a time. In general, a concentration of the luminescence center element in the particle is excessively-high, concentration quenching occurs and luminance becomes low. In this case, a particle having a luminescence center element at high concentration has high conductivity, whereas a particle having a luminescence center element at low concentration has high-luminance light emission. Therefore, since the present invention is applied to a dispersion-type light-emitting element, a light-emitting element with high luminance and low power consumption can be obtained by the mixture of particles different in concentration.

As a formation method of the light-emitting layer, a droplet-discharging method which can selectively form a light-emitting layer, a printing method such as screen printing or offset printing, a coating method such as spin coating, a dipping method, a dispenser method, or the like can be used. There are no particular limitations on the film thickness; however, a film thickness in the range of 10 to 1000 nm is preferable. In the light-emitting layer including the light-emitting material and the binder, the ratio of the light-emitting material is preferable greater than or equal to 50 wt % and less than or equal to 80 wt %.

As the binder used in this embodiment mode, an insulating material such as an organic material, an inorganic material, or a mixed material of an organic material and an inorganic material can be used. As the organic material, the following resin material can be used: a polymer having a comparatively high dielectric constant such as a cyanoethyl cellulose based resin, polyethylene, polypropylene, a polystyrene based resin, a silicone resin, an epoxy resin, vinylidene fluoride, or the like. In addition, a heat-resistant high-molecular material such as aromatic polyamide or polybenzimidazole, or a siloxane resin may also be used. Note that the siloxane resin is a resin including a Si—O—Si bond. Moreover, the following resin material can also be used: a vinyl resin such as polyvinyl alcohol or polyvinylbutyral, a phenol resin, a novolac resin, an acrylic resin, a melamine resin, a urethane resin, an oxazole resin (polybenzoxazole), or the like. On the other hand, the inorganic material can be formed with a material selected from silicon oxide, silicone nitride, silicon oxynitride, silicon nitride oxide, aluminum nitride, aluminum oxynitride, aluminum nitride oxide, aluminum oxide, titanium oxide, barium titanate, strontium titanate, lead titanate, potassium niobate, lead niobate, tantalum oxide, barium tantalate, lithium tantalate, yttrium oxide, zirconium oxide, zinc sulfide, or other substances containing an inorganic material. Note that a material where an inorganic material having a high dielectric constant is added to an organic material may also be used. Accordingly, a dielectric constant of a light-emitting layer can be controlled, and the dielectric constant can be further increased.

In the manufacturing process of the light-emitting layer 202, the light-emitting material is dispersed in a solution containing the binder. As a solvent for the solution containing a binder that can be used in this embodiment mode, a solvent capable of forming a solution having a viscosity such that it can dissolve a binder material and is suitable for a method for forming a light-emitting layer (various wet processes) and a desired film thickness, may be appropriately selected. When, for example, a siloxane resin is used as a binder, propylene glycol monomethyl ether, propylene glycol monomethyl ether acetate (PGMEA), 3-methoxy-3-methyl-1-butanol (MMB), or the like can be used as an organic solvent.

There is no particular limitation on the insulating layer 203 in FIG. 5; however, the insulating layer 203 preferably has a high dielectric strength voltage, dense film quality, and further, a high dielectric constant. For example, yttrium oxide, titanium oxide, aluminum oxide, hafnium oxide, tantalum oxide, barium titanate, strontium titanate, lead titanate, silicon nitride, zirconium oxide, silicon oxide, or the like, a mixed film thereof, or a stacked film containing two or more kinds of the above materials can be used. These insulating films can be formed by sputtering, evaporation, CVD, or the like. In addition, particles of these insulating materials may be dispersed in a binder to form the insulating layer 203. The binder material for forming the insulating layer can be formed using materials and methods similar to those of the binder contained in the light-emitting layer. There is no particular limitation on the film thickness; however, the film thickness is preferably in the range of 10 to 1000 nm.

A light-emitting element of the present invention can have less concentration quenching and high emission efficiency because a light-emitting material having high purity is used. Therefore, a light-emitting element having high luminance can be obtained. In other words, a light-emitting element having high luminance, which can be obtained when a certain voltage is applied, can be obtained.

Note that this embodiment mode can appropriately be combined with other embodiment modes.

### Embodiment Mode 6

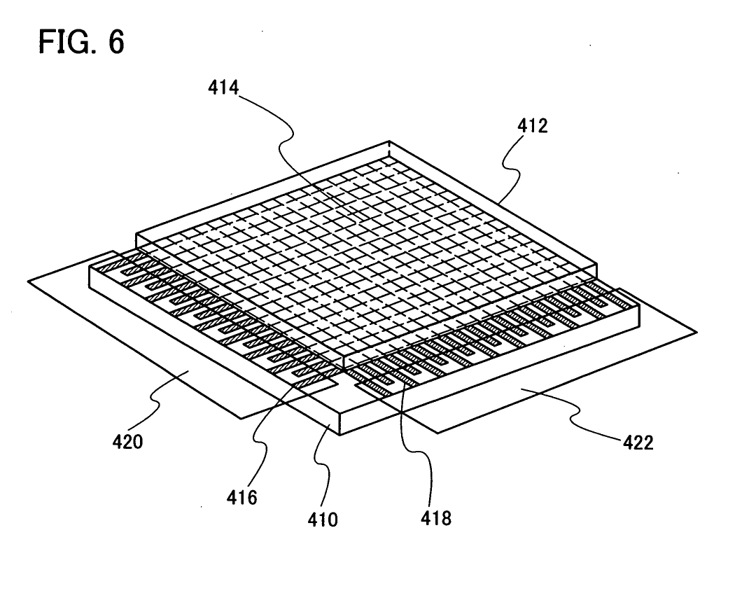

This embodiment mode will explain a display device as one mode of the light-emitting device with reference to FIGS. 6 to 8, FIGS. 9A and 9B, and FIGS. 10A and 10B.

FIG. 6 is a schematic configuration diagram showing a main portion of the display device. Over a substrate 410, a first electrode 416 and a second electrode 418 that extends in a direction intersecting with the first electrode 416 are provided. A light-emitting layer similar to that described in Embodiment Mode 5 is provided at least at the intersection portion of the first electrode 416 and the second electrode 418; thus, a light-emitting element is formed. In a light-emitting device of FIG. 6, a plurality of first electrodes 416 and a plurality of second electrodes 418 are disposed and light-emitting elements of pixels are arranged in matrix; thus, a display portion 414 is formed. In this display portion 414, potential of the first electrode 416 and the second electrode 418 is controlled so that emission and non-emission of each light-emitting element are controlled. In such a manner, the display portion 414 can display moving images and still images.

In this light-emitting device, a signal for displaying an image is applied to each of the first electrode 416 extending in one direction over the substrate 410 and the second electrode 418 that intersects with the first electrode 416; thus, emission or non-emission of a light-emitting element is selected. In other words, this is a simple matrix display device of which pixels are driven solely by a signal given from an external circuit. Such a display device has a simple structure and can be manufactured easily even when the area is enlarged.

In the above, when the first electrode 416 is formed using aluminum, titanium, tantalum or the like, and the second electrode 418 is formed using indium oxide, indium tin oxide, indium zinc oxide, or zinc oxide, a display device having the display portion 414 on the side of a counter substrate 412 can be provided. In this case, when a thin oxide film is formed over a surface of the first electrode 416, a barrier layer is formed and luminous efficiency can be improved because of a carrier blocking effect. When the first electrode 416 is formed using indium oxide, indium tin oxide, indium zinc oxide, or zinc oxide, and the second electrode 418 is formed using aluminum, titanium, tantalum or the like, a display device having the display portion 414 on side of the substrate 410 can be provided. Moreover, when both the first electrode 416 and the second electrode 418 are formed of transparent electrodes, a dual emission display device can be provided.

The counter substrate 412 may be provided if necessary, and it can serve as a protective member when provided adjusting to the position of the display portion 414. Even if a hard plate member is used, a resin film or a resin material can be applied instead. The first electrode 416 and the second electrode 418 are led to end portions of the substrate 410 to form terminals to be connected to external circuits. In other words, the first electrode 416 and the second electrode 418 are in contract with flexible wiring boards 420 and 422 at the end portions of the substrate 410. As the external circuits, there are a power supply circuit, a tuner circuit, and the like, in addition to a controller circuit that controls a video signal.

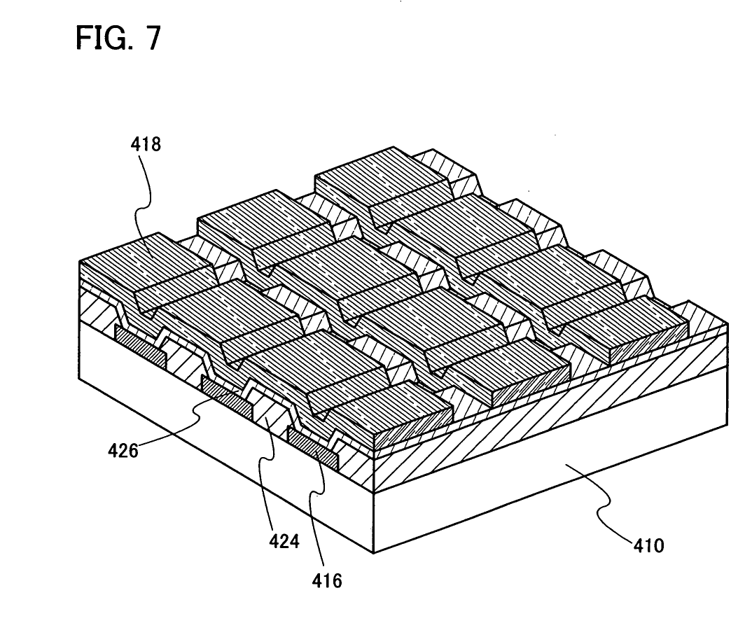

FIG. 7 is a partial enlarged view showing a structure of the display portion 414. A partition layer 424 is formed on a side end portion of the first electrode 416 formed over the substrate 410. An EL layer 426 is formed at least over an exposed surface of the first electrode 416. The second electrode 418 is formed over the EL layer 426. The second electrode 418 intersects with the first electrode 416 so that the second electrode 418 extends over the partition layer 424. The partition layer 424 is formed of an insulating material so that a short circuit between the first electrode 416 and the second electrode 418 does not occur. In a portion where the partition layer 424 covers the end portion of the first electrode 416, a side end portion of the partition layer 424 is sloped so as not to form a steep step, such that it has a so-called tapered shape. When the partition layer 424 has such a shape, coverage of the EL layer 426 and the second electrode 418 improves, and defects such as cracks or tear can be prevented.

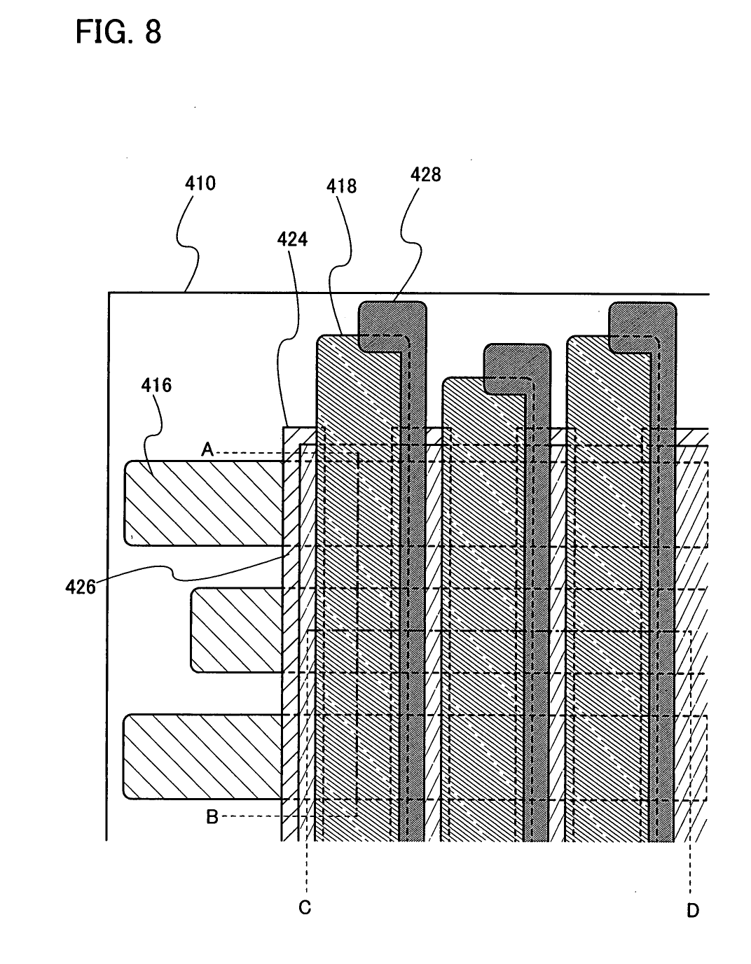

FIG. 8 is a plane view of the display portion 414, which shows the arrangement of the first electrode 416, the second electrode 418, the partition layer 424, and the EL layer 426. In the case where the second electrode 418 is formed of a transparent conductive film of an oxide such as indium tin oxide or zinc oxide, an auxiliary electrode 428 is preferably provided so as to reduce the resistance loss. In this case, the auxiliary electrode 428 may be formed using a refractory metal such as titanium, tungsten, chromium, or tantalum, or a combination of the refractory metal and a low resistance metal such as aluminum or silver.

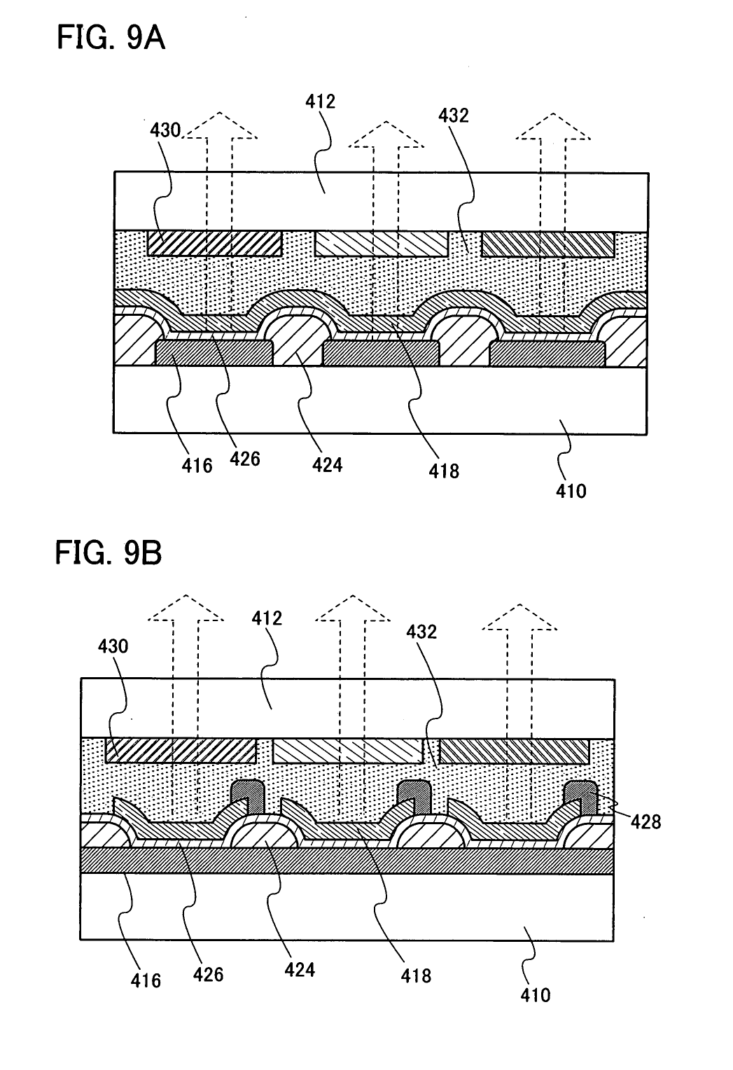

FIGS. 9A and 9B show cross-sectional views taken along the line A-B and the line C-D in FIG. 8, respectively. FIG. 9A is a cross-sectional view in which the first electrodes 416 are arranged, and FIG. 9B is a cross-sectional view in which the second electrodes 418 are arranged. The EL layer 426 is formed at the intersection portion of the first electrode 416 and the second electrode 418, and light-emitting element is formed in the portion. The auxiliary electrode 428 shown in FIG. 9B is provided over the partition layer 424 and in contact with the second electrode 418. The auxiliary electrode 428 formed over the partition layer 424 does not block light from the light-emitting element formed at the intersection portion of the first electrode 416 and the second electrode 418; therefore, the emitted light can efficiently be utilized. In addition, a short circuit between the auxiliary electrode 428 and the first electrode 416 can be prevented.

In each of FIGS. 9A and 9B, an example in which a color conversion layer 430 is provided for the counter substrate 412 is shown. The color conversion layer 430 converts the wavelength of light emitted from the EL layer 426 so as to change the color of the emitted light. In this case, light emitted from the EL layer 426 is preferably blue light or ultraviolet light with high energy. When the color conversion layers 430 for converting light to red, green, and blue light are arranged, a display device that performs RGB full-color display can be provided. Moreover, the color conversion layer 430 can be replaced by a colored layer (color filter). In this case, the EL layer 426 may be made to emit white light. A filler 432 may appropriately be provided to fix the substrate 410 and the counter substrate 412 to each other.

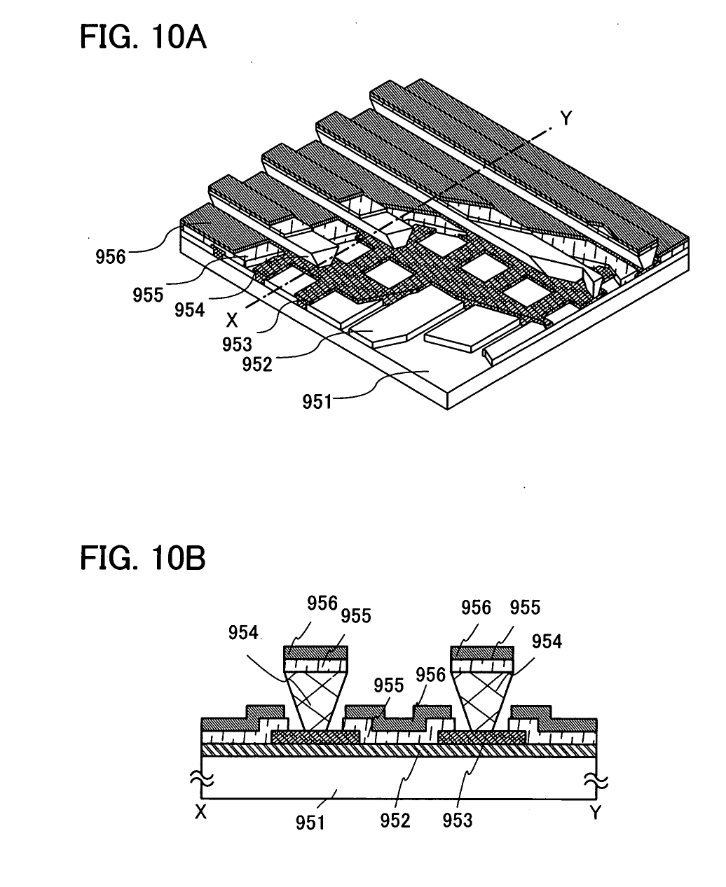

Another structure of the display portion 414 is shown in FIGS. 10A and 10B. In the structure shown in FIGS. 10A and 10B, an end portion of a first electrode 952 provided over a substrate 951 is covered with an insulating layer 953. In addition, a partition layer 954 is provided over the insulating layer 953. Sidewalls of the partition layer 954 have a slant such that a distance between one sidewall and the other sidewall becomes shorter as the sidewalls gets closer to the substrate surface. In other words, a cross section taken along the direction of a shorter side of the partition layer 954 has a trapezoidal shape, and the base of the trapezoid (a side of the trapezoid that is in contact with the insulating layer 953) is shorter than the upper side of the trapezoid (a side of the trapezoid that is not in contact with the insulating layer 953). The partition layer 954 is provided in such a manner, whereby an EL layer 955 and a second electrode 956 can be formed in a self-aligning manner with the partition layer 954.

Since the display device of this embodiment mode has high luminance, which can be obtained when a certain voltage is applied, the power consumption can be reduced.

### Embodiment Mode 7

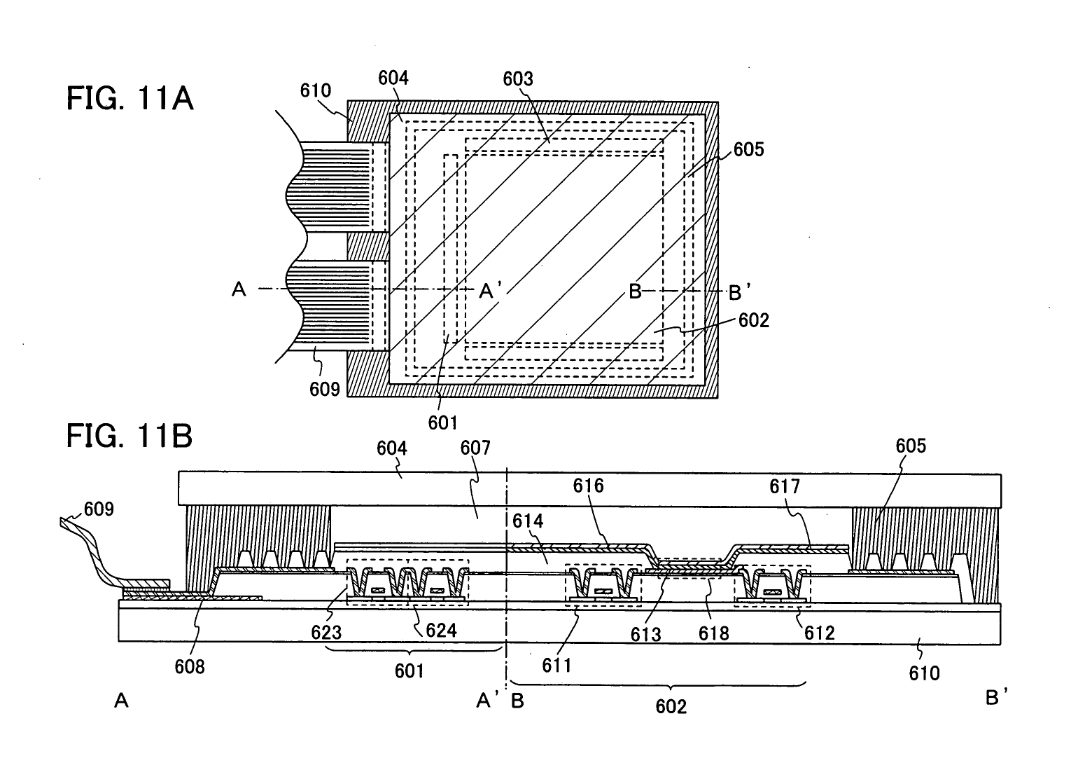

This embodiment mode will explain an active light-emitting device in which the drive of a light-emitting element is controlled by a transistor. In this embodiment mode, a light emitting-device including the light-emitting element manufactured by application of the present invention to a pixel portion will be explained with reference to FIGS. 11A and 11B. Note that FIG. 11A is a top view showing the light-emitting device and FIG. 11B is a cross-sectional view taken along lines A-A′ and B-B′ of FIG. 11A. In FIGS. 11A and 11B, concerning the reference numerals for the areas shown by dotted lines, 601 denotes a driver circuit portion (a source side driver circuit); 602, a pixel portion; and 603, a driver circuit portion (a gate side driver circuit). Moreover, reference numeral 604 denotes a sealing substrate; 605, a sealant; and 607, a space surrounded by the sealant 605.

Note that a lead wiring 608 is a wiring for transmitting signals to be inputted to the source side driver circuit 601 and the gate side driver circuit 603 and receives a video signal, a clock signal, a start signal, a reset signal, or the like from an FPC (flexible printed circuit) 609 that serves as an external input terminal. Note that only the FPC is shown here; however, the FPC may be provided with a printed wiring board (PWB). The light-emitting device in this specification includes not only a main body of the light-emitting device but also the light-emitting device with an FPC or a PWB attached.

Next, the cross-sectional structure is explained with reference to FIG. 11B. The driver circuit portion and the pixel portion are formed over an element substrate 610. Here, the source side driver circuit 601 that is the driver circuit portion and one pixel in the pixel portion 602 are shown.

Note that a CMOS circuit that is a combination of an n-channel TFI (also referred to as a thin film transistor) 623 and a p-channel TFT 624 is formed as the source side driver circuit 601. The driver circuit may be any one of various circuits such as a CMOS circuit, a PMOS circuit, and an NMOS circuit. A driver-integrated type structure in which a driver circuit and a pixel portion are formed over the same substrate is described in this embodiment mode; however, the driver-integrated type structure is not always necessary. A driver circuit can be formed external to the substrate, rather than over the substrate. Note that there is no particular limitation on the structure of the TFT. A staggered TFT or an inversely staggered TFT may be used, for example. Moreover, there is no particular limitation on the crystallinity of a semiconductor film used in the TFT. An amorphous semiconductor film may also be used, or a crystalline semiconductor film may also be used. Further, there is no particular limitation on a semiconductor material. An inorganic compound may also be used, or an organic compound may also be used.

In addition, the pixel portion 602 includes a plurality of pixels, each of which includes a switching TFT 611, a current control TFT 612, and a first electrode 613 which is electrically connected to a drain of the current control TFT 612. Note that an insulator 614 is formed to cover an end portion of the first electrode 613. Here, a positive type photosensitive acrylic resin film is used to form the insulator 614.

The insulator 614 is formed to have a curved surface with curvature at an upper end portion or a lower end portion thereof in order to obtain favorable coverage. For example, in the case of using positive type photosensitive acrylic resin as a material of the insulator 614, the insulator 614 is preferably formed to have a curved surface with a curvature radius (0.2 to 3 μm) only at an upper end portion. Either a negative type which becomes insoluble in an etchant by light irradiation or a positive type which becomes soluble in an etchant by light irradiation can be used as the insulator 614.

An EL layer 616 and a second electrode 617 are formed over the first electrode 613. At least one of the first electrode 613 and the second electrode 617 has a light-transmitting property, through which light emitted from the EL layer 616 can be extracted outside.

The EL layer 616 includes the light-emitting layer described in Embodiment Mode 5.

Note that the first electrode 613, the EL layer 616, and the second electrode 617 can be formed by various methods. Specifically, they can be formed by a vacuum evaporation method such as a resistance heating evaporation method or an electron beam (EB) evaporation method, a physical vapor deposition (PVD) method such as a sputtering method, a chemical vapor deposition (CVD) method such as a metal organic CVD method or a low-pressure hydride transport CVD method, an atomic layer epitaxy (ALE) method, or the like. Moreover, an ink-jet method, a spin coating method, or the like can be used. Further, a different film formation method may be employed to form each electrode or layer.

The sealing substrate 604 is attached to the element substrate 610 with the sealant 605, whereby a light-emitting element 618 is provided in the space 607 surrounded by the element substrate 610, the sealing substrate 604, and the sealant 605. Note that the space 607 is filled with a filler. There are cases where the space 607 may be filled with an inert gas (such as nitrogen or argon) as such a filler, or where the space 607 may be filled with the sealant 605.

Note that an epoxy-based resin is preferably used as the sealant 605. In addition, it is preferable that materials used for the sealant and the filler be materials which allow as little water and oxygen as possible to penetrate. As the material used for the sealing substrate 604, a plastic substrate formed of FRP (Fiberglass-Reinforced Plastics), PVF (polyvinyl fluoride), Mylar (registered trademark), polyester, acryl, or the like can be used besides a glass substrate or a quartz substrate.

As described above, the light-emitting device including the light-emitting element formed by application of the present invention can be obtained.

The light-emitting device shown in this embodiment mode includes the light-emitting element described in Embodiment Mode 5, and can have high luminance.

In addition, since the light-emitting device shown in this embodiment mode has high luminance, which can be obtained when a certain voltage is applied, the power consumption can be reduced.

### Embodiment Mode 8

This embodiment mode will explain electronic devices of the present invention which include, as parts thereof, the light-emitting device described in any of Embodiment Modes 6 and 7. The electronic device shown in this embodiment mode includes the light-emitting element described in Embodiment Mode 5. Thus, an electronic device with reduced power consumption can be provided because the electronic device shown in this embodiment mode includes a light-emitting element having high luminance, which can be obtained when a certain voltage is applied, that is, a light-emitting element with high luminous efficiency.

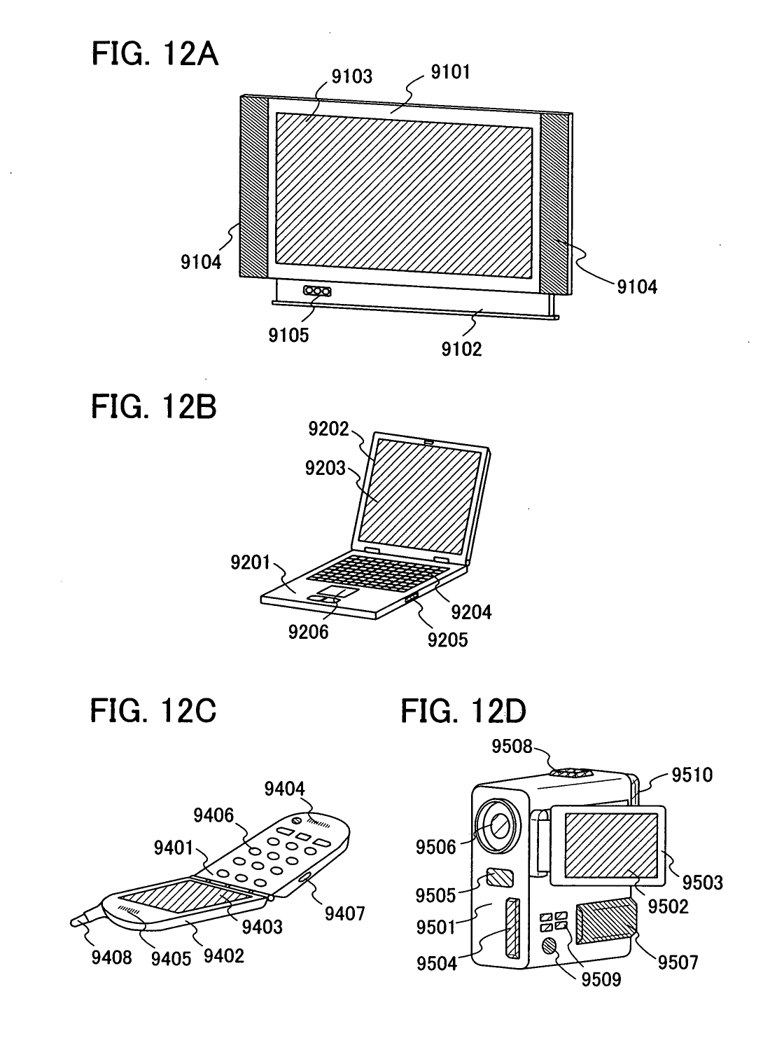

Examples of the electronic device manufactured by the application of the present invention are as follows: a television device, a camera such as a video camera or a digital camera, a goggle type display, a navigation system, a sound reproducing device (a car audio system, an audio component, or the like), a computer, a game machine, a portable information terminal (a mobile computer, a cellular phone, a mobile game machine, an electronic book, or the like), an image reproducing device having a recording medium (specifically, devices for reproducing a content of a recording medium such as digital versatile disc (DVD) and having a display for displaying the image), and the like. Specific examples of these electronic devices are shown in FIGS. 12A to 12D.

FIG. 12A shows a television device in accordance with this embodiment mode, which includes a housing 9101, a supporting base 9102, a display portion 9103, a speaker portion 9104, a video input terminal 9105, and the like. In this television device, the display portion 9103 includes light-emitting elements which are arranged in matrix, each of which is similar to the light-emitting element explained in Embodiment Mode 5. The light-emitting element has a feature of high luminous efficiency. The display portion 9103 which includes the light-emitting element also has a similar feature. Therefore, in the television device, deterioration in image quality is reduced and low power consumption is achieved. With such features, a deterioration compensation function and a power supply circuit can be significantly reduced or downsized, whereby reductions in size and weight of the housing 9101 and the support base 9102 can be achieved. The television device of this embodiment mode has low power consumption, high image quality, and reduced size and weight; therefore, a product which is suited to a living environment can be provided.

FIG. 12B shows a computer in accordance with this embodiment mode, which includes a main body 9201, a housing 9202, a display portion 9203, a keyboard 9204, an external connection port 9205, a pointing device 9206, and the like. In this computer, the display portion 9203 includes light-emitting elements which are arranged in matrix, each of which is similar to the light-emitting element explained in Embodiment Mode 5. The light-emitting element has a feature of high luminous efficiency. The display portion 9203 which includes the light-emitting element has a similar feature. Therefore, in this computer, deterioration in image quality is reduced and low power consumption is achieved. With such features, a deterioration compensation function and a power supply circuit can be significantly reduced or downsized in the computer, whereby reductions in size and weight of the main body 9201 and the housing 9202 can be achieved. The computer of this embodiment mode has low power consumption, high image quality, and reduced size and weight; therefore, a product which is suited to an environment can be provided.

FIG. 12C shows a cellular phone in accordance with this embodiment mode, which includes a main body 9401, a housing 9402, a display portion 9403, an audio input portion 9404, an audio output portion 9405, operation keys 9406, an external connection port 9407, an antenna 9408, and the like. In this cellular phone, the display portion 9403 includes light-emitting elements which are arranged in matrix, each of which is similar to the light-emitting element explained in Embodiment Mode 5. The light-emitting element has a feature of high luminous efficiency. The display portion 9403 which includes the light-emitting element also has a similar feature. Therefore, in this cellular phone, deterioration in image quality is reduced and low power consumption is achieved. With such features, a deterioration compensation circuit and a power supply circuit can be significantly reduced or downsized in the cellular phone. Therefore, the main body 9401 and the housing 9402 can be made smaller and lighter. The cellular phone of this embodiment mode has low power consumption, high image quality, and reduced size and weight; therefore, a product which is suited to being carried can be provided.

FIG. 12D shows a camera in accordance with this embodiment mode, which includes a main body 9501, a display portion 9502, a housing 9503, an external connection port 9504, a remote control receiving portion 9505, an image receiving portion 9506, a battery 9507, an audio input portion 9508, operation keys 9509, an eyepiece portion 9510, and the like. In this camera, the display portion 9502 includes light-emitting elements which are arranged in matrix, each of which is similar to the light-emitting element explained in Embodiment Mode 5. The light-emitting element has a feature of high luminous efficiency. The display portion 9502 which includes the light-emitting element also has similar features. Therefore, in this camera, deterioration in image quality is reduced and low power consumption is achieved. With such features, a deterioration compensation circuit and a power supply circuit can be significantly reduced or downsized in the camera. Therefore, the main body 9501 of the camera can be made smaller and lighter. The camera of this embodiment mode has low power consumption, high image quality, and reduced size and weight; therefore, a product which is suited to being carried can be provided.

As described above, the range of application of the light-emitting device manufactured by application of the present invention is very wide. The light-emitting device can be applied to electronic devices in all kinds of fields. By application of the present invention, an electronic device including a display portion which consumes low power and has high reliability can be manufactured.

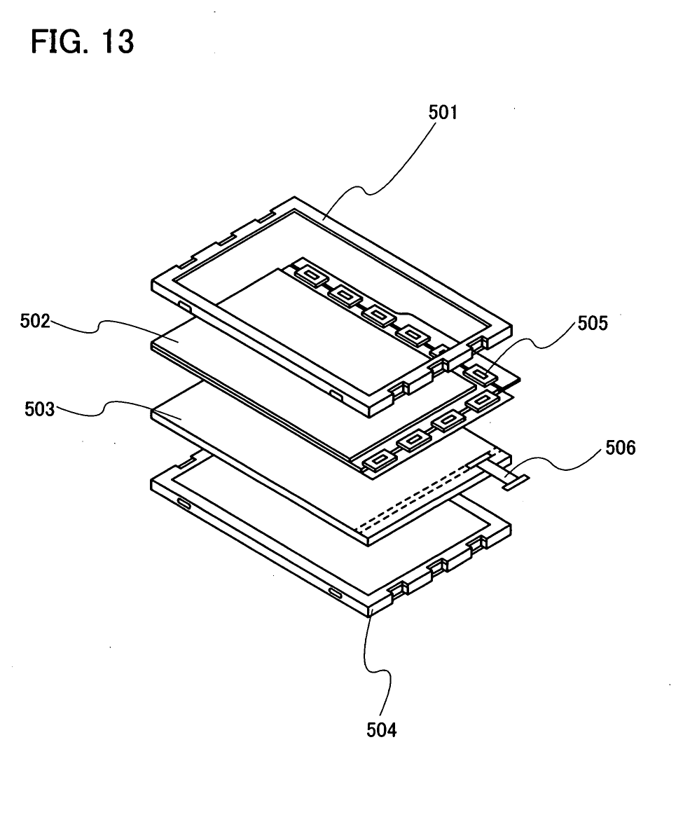

In addition, the light-emitting device to which the present invention is applied can also be used as a lighting system. One mode of using the light-emitting element to which the present invention is applied as a lighting system will be described with reference to FIG. 13.

FIG. 13 shows an example of a liquid crystal display device using the light-emitting device to which the present invention is applied as a backlight. The liquid crystal display device shown in FIG. 13 includes a housing 501, a liquid crystal layer 502, a backlight 503, and a housing 504. The liquid crystal layer 502 is connected to a driver IC 505. The light-emitting device of the present invention is used as the backlight 503, to which a voltage is applied through a terminal 506.

With the use of the light-emitting device of the present invention as a backlight of a liquid crystal display device, a backlight having high luminance and a long life can be obtained; therefore, the quality as a display device is improved. In addition, since a light-emitting device of the present invention is a plane emission light-emitting device and can have a large surface area, the backlight can have a large surface area; therefore, the liquid crystal display device can also have a large surface area. Further, since the light-emitting element is thin and has low power consumption, a display device having a backlight, which is made thin and of which power consumption is reduced, can be provided.

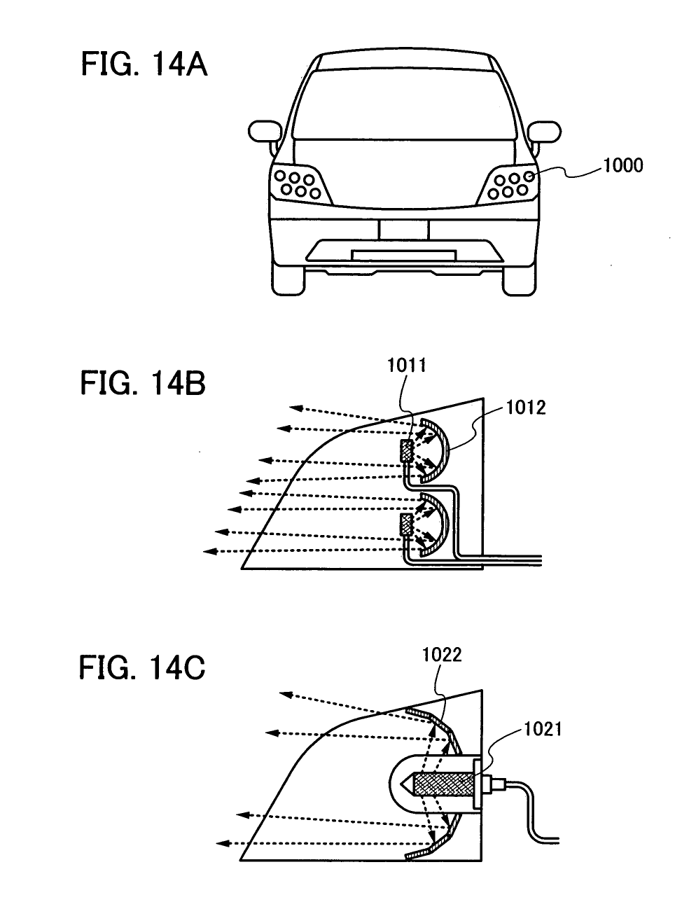

Moreover, since a light-emitting device to which the present invention is applied can emit light having high luminance, the light-emitting device can be used as a headlight of a car, bicycle, ship, or the like. FIGS. 14A to 14C show an example in which the light-emitting device to which the present invention is applied is used as a headlight of a car. FIG. 14B is an enlarged cross-sectional view showing a headlight 1000 of FIG. 14A. In FIG. 14B, the light-emitting device of the present invention is used as a light source 1011. Light emitted from the light source 1011 is reflected on a reflector 1012 and taken outside. As shown in FIG. 14B, light with higher luminance can be obtained with the use of a plurality of light sources. FIG. 14C is an example in which the light-emitting device of the present invention that is manufactured in a cylindrical shape is used as a light source. Light emitted from the light source 1021 is reflected on a reflector 1022 and taken outside.

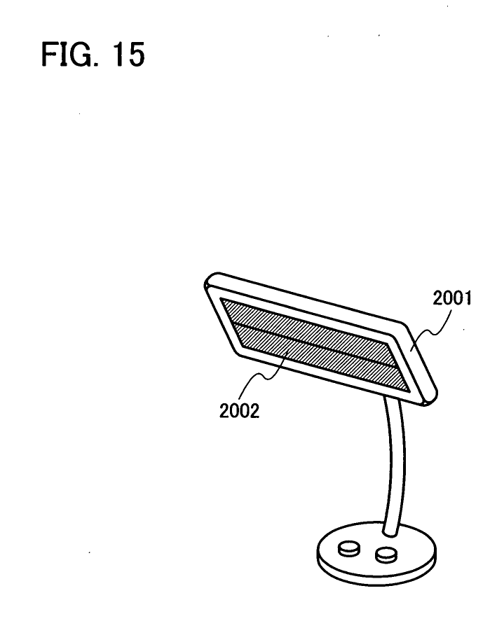

FIG. 15 shows an example in which a light-emitting device to which the present invention is applied is used as a desk lamp that is one of lighting systems. The desk lamp shown in FIG. 15 includes a housing 2001 and a light source 2002, and the light-emitting device of the present invention is used as the light source 2002. Since the light-emitting device of the present invention can emit light having high luminance, the desk lamp can brightly illuminate hands in a case such as where fine handwork is being done.

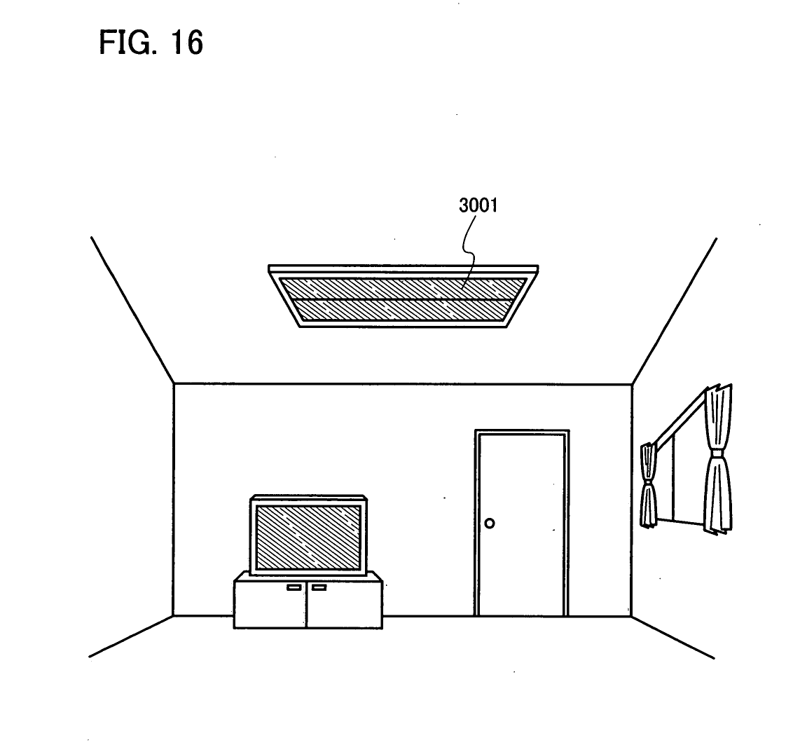

FIG. 16 shows an example in which a light-emitting device to which the present invention is applied is used as an interior lighting system 3001. Since the light-emitting device of the present invention can have a large area, the light-emitting device can be used as a large-area lighting system. In addition, since the light-emitting device of the present invention is thin and consumes low power, the light-emitting device can be used as a thin lighting system with low power consumption. In such a manner, a television device of the present invention as explained in FIG. 12A may be set in a room where the light-emitting device to which the present invention is applied is used as the indoor lighting system 3001, and public broadcasting or movies can be appreciated there. In such a case, powerful images can be appreciated in a bright room while saving electricity costs, because both the lighting system and the television device consume low power.

Lighting systems are not limited to those exemplified in FIGS. 14A to 14C, FIG. 15, and FIG. 16, and the light-emitting device of the present invention can be applied to lighting systems in various modes, including lighting systems for houses and public facilities. The light-emitting layer of the lighting system of the present invention is formed in a thin film, which increases design freedom. Therefore, various elaborately-designed products can be provided to the marketplace.

Hereinafter, details of the present invention will be explained using embodiments.

### Embodiment 1

ZnS, CuSO₄, MgCl₂, and NaCl were each weighed to be 50 g, 0.0818 g, 4.8865 g, and 0.2999 g, and stirred and mixed in an agate mortal The above ZnS, CuSO₄, MgCl₂, and NaCl were appropriately mixed, and then the mixture was put in an alumina container and baked in an electric furnace which was under an Ar atmosphere for 4 hours at 1000° C. The obtained light-emitting material (hereinafter, regarded as ZnS: Cu, Cl) was grayish white. The light-emitting material was irradiated with UV light at wavelengths of 254 nm and 356 nm, and bluish green light emission was observed in both cases.

Next, Mn was weighed to be 0.7114 g and was put in an alumina container while Mn was made not to attach to side wall of the alumina container as much as possible. The alumina container was vibrated appropriately, and the surface of Mn was made flat. ZnS: Cu, Cl weighed 3.9430 g was added thereover and the alumina container was vibrated to make the surface of ZnS: Cu, Cl flat. The alumina container was made lidded and baking was performed using an electric furnace which was under an Ar atmosphere for 4 hours at 1100° C. After the baking, the light-emitting material was taken out from the alumina container while the materials was irradiated with UV light at a wavelength of 365 nm, and light-emitting materials each different in a light-emitting color in depth direction were formed in contact with Mn. Parts of the light-emitting material are each to be referred to as a lower-layer area, a middle-layer area, and an upper-layer area sequentially from the portion in contact with Mn. In this embodiment, three kinds of light-emitting color were obtained, and different color emission was performed in each area. Note that, since Mn was melted and solidified at the bottom of the alumina container, Mn was easily separated from the light-emitting material.

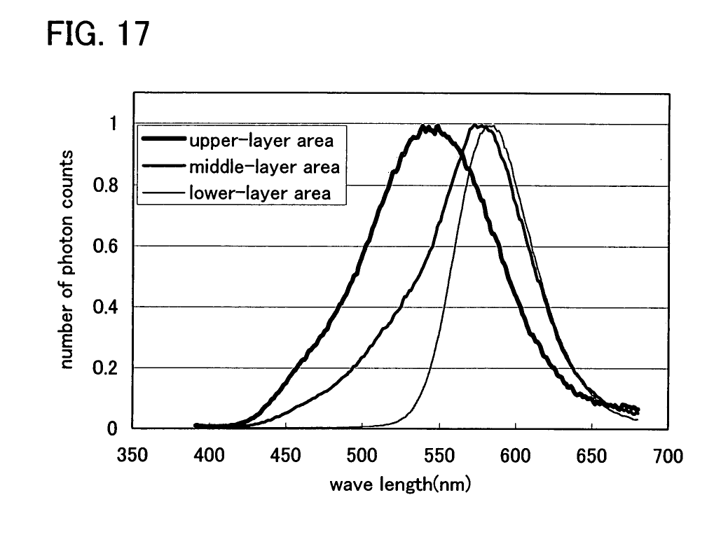

FIG. 17 shows PL spectra of the obtained light-emitting material. A horizontal axis and a vertical axis indicate a wavelength (nm) and a normalized photon count number, respectively. An orange PL spectrum caused by Mn²⁺ was obtained in the lower-layer region, and a bluish green PL spectrum of a donor-acceptor pair recombination type caused by Cu⁺ and Cl⁻ was obtained in the upper-layer region. Note that the orange PL spectrum caused by Mn²⁺ and the bluish green PL spectrum caused by Cu⁺ and Cl⁻ were obtained in the middle-layer region.

Accordingly, regardless of the amount of a luminescence center material, the light-emitting material having a plurality of luminescence wavelengths was obtained. In addition, since flux or the like is not used, a light-emitting material having high purity was obtained.

### Embodiment 2

An alumina container was put in a quartz tube, and Mn weighed 0.774 g was put in a quartz tube and the alumina tube was vibrated to make the surface of Mn flat. ZnS: Cu, Cl weighed 3.9430 g was added thereover and the alumina tube was vibrated to make the surface of ZnS: Cu, Cl flat. Next, exhaustion is performed to the quartz tube so that a pressure thereof becomes less than or equal to 1×10⁻⁴ (Pa), and the quartz tube, where the alumina container was put, was sealed using a burner. Thereafter, baking is performed using an electric furnace which was under an N₂ atmosphere for 4 hours at 1250° C. The obtained light-emitting material was grayish white. The light-emitting material was taken out from the alumina container while the material was irradiated with UV light at a wavelength of 356 nm, and light-emitting materials each different in a light-emitting color in depth direction were formed in contact with Mn. Parts of the light-emitting material are each to be referred to as a lower-layer area, a middle-layer area, and an upper-layer area sequentially from the portion in contact with Mn. In this embodiment, two kinds of light-emitting color were obtained, and the same color emission was performed in the lower-layer and upper-layer regions, whereas color emission different from the lower-layer and upper-layer region was performed in the middle-layer region. Note that, since Mn was melted and solidified at the bottom of the alumina container, Mn was easily separated from the light-emitting material.

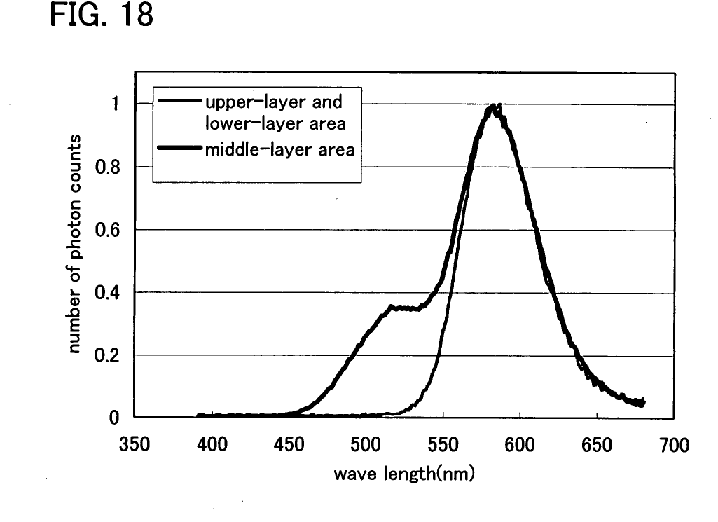

FIG. 18 shows PL spectra of the obtained light-emitting material. A horizontal axis and a vertical axis indicate a wavelength (nm) and a normalized photon count number, respectively. An orange PL spectrum caused by Mn²⁺ was obtained in the lower-layer region and the upper-layer region, and a bluish green PL spectrum of a donor-acceptor pair recombination type caused by Cu⁺ and Cr⁻ and the orange PL spectrum caused by Mn²⁺ were obtained in the middle-layer region.

Accordingly, regardless of the amount of a luminescence center material, the light-emitting material having a plurality of luminescence wavelengths was obtained. In addition, since flux or the like is not used, a light-emitting material having high purity was obtained.

The present application is based on Japanese Patent Application serial No. 2006-155280 filed on Jun. 2, 2006 in Japan Patent Office, the entire contents of which are hereby incorporated by reference.

What is claimed is:

1. A method for manufacturing a light-emitting material comprising the steps of:
forming a first layer containing a first luminescence center element in a container;
forming a second layer containing a host material adjacent to the first layer in the container; and
doping the second layer with the first luminescence center element by performing heat treatment to the first layer and the second layer in the container.

2. The method for manufacturing a light-emitting material according to claim 1, wherein the heat treatment is performed at a temperature greater than or equal to 700° C. and less than or equal to 1500° C.

3. The method for manufacturing a light-emitting material according to claim 1, wherein the heat treatment is performed under a sulfidation-gas atmosphere.

4. The method for manufacturing a light-emitting material according to claim 1, wherein the first luminescence center element is at least one selected from the group consisting of copper, silver, gold, manganese, terbium, europium, thulium, cerium, praseodymium, samarium, erbium, aluminum, chlorine, and fluorine.

5. The method for manufacturing a light-emitting material according to claim 1, wherein the host material is at least one selected from the group consisting of zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium-aluminum sulfide, calcium-gallium sulfide, strontium-gallium sulfide, and barium-gallium sulfide.

6. The method for manufacturing a light-emitting material according to claim 1, wherein the first layer contains a second luminescence center element different from the first luminescence center element.

7. The method for manufacturing a light-emitting material according to claim 6, wherein a light-emission color from the first luminescence center element and a light-emission color from the second luminescence center element are in a relation of a complementary color.

8. A method for manufacturing a light-emitting material comprising the steps of:
forming a first layer containing a first luminescence center element in a container;
forming a second layer containing a host material over the first layer in the container; and
doping the second layer with the first luminescence center element by performing heat treatment to the first layer and the second layer in the container.

9. The method for manufacturing a light-emitting material according to claim 8, wherein the heat treatment is performed at a temperature greater than or equal to 700° C. and less than or equal to 1500° C.

10. The method for manufacturing a light-emitting material according to claim 8, wherein the heat treatment is performed under a sulfidation-gas atmosphere.

11. The method for manufacturing a light-emitting material according to claim 8, wherein the first luminescence center element is at least one selected from the group consisting of copper, silver, gold, manganese, terbium, europium, thulium, cerium, praseodymium, samarium, erbium, aluminum, chlorine, and fluorine.

12. The method for manufacturing a light-emitting material according to claim 8, wherein the host material is at least one selected from the group consisting of zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium-aluminum sulfide, calcium-gallium sulfide, strontium-gallium sulfide, and barium-gallium sulfide.

13. The method for manufacturing a light-emitting material according to claim 8, wherein the first layer contains a second luminescence center element different from the first luminescence center element.

14. The method for manufacturing a light-emitting material according to claim 13, wherein a light-emission color from the first luminescence center element and a light-emission color from the second luminescence center element are in a relation of a complementary color.

15. A method for manufacturing a light-emitting material comprising the steps of:
forming a first layer containing a first luminescence center element in a container;
forming a second layer containing a second luminescence center element and a host material adjacent to the first layer in the container; and
doping the second layer with the first luminescence center element by heating the first layer and the second layer in the container.

16. The method for manufacturing a light-emitting material according to claim 15, wherein the heat treatment is performed at a temperature greater than or equal to 700° C. and less than or equal to 1500° C.

17. The method for manufacturing a light-emitting material according to claim 15, wherein the heat treatment is performed under a sulfidation-gas atmosphere.

18. The method for manufacturing a light-emitting material according to claim 15, wherein the first luminescence center element is at least one selected from the group consisting of copper, silver, gold, manganese, terbium, europium, thulium, cerium, praseodymium, samarium, erbium, aluminum, chlorine, and fluorine.

19. The method for manufacturing a light-emitting material according to claim 15, wherein the host material is at least one selected from the group consisting of zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium-aluminum sulfide, calcium-gallium sulfide, strontium-gallium sulfide, and barium-gallium sulfide.

20. The method for manufacturing a light-emitting material according to claim 15, wherein the first layer contains a third luminescence center element different from the first luminescence center element.

21. The method for manufacturing a light-emitting material according to claim 20, wherein a light-emission color from the first luminescence center element, a light-emission color from the second luminescence center element and a light-emission color from the third luminescence center element are in a relation of a complementary color.

22. A light-emitting element comprising:
a pair of electrodes;
a light-emitting layer between the pair of electrodes and comprising:
a binder; and
a plurality of particles of a light-emitting material which contains a first luminescence center element,
wherein the plurality of particles have different concentrations of the first luminescence center element.

23. The light-emitting element according to claim 22 further comprising an insulating layer between the pair of electrodes.

24. The light-emitting element according to claim 22, wherein the insulating layer comprises at least one selected from the group consisting of yttrium oxide, titanium oxide, aluminum oxide, hafnium oxide, tantalum oxide, silicon oxide, barium titanate, strontium titanate, lead titanate, silicon nitride, and zirconium oxide.

25. The light-emitting element according to claim 22, wherein the first luminescence center element is at least one selected from the group consisting of copper, silver, gold, manganese, terbium, europium, thulium, cerium, praseodymium, samarium, erbium, aluminum, chlorine, and fluorine.

26. The light-emitting element according to claim 22,
wherein the light-emitting material contains a second luminescence center element,
wherein the second luminescence center element is at least one selected from the group consisting of copper, silver, gold, manganese, terbium, europium, thulium, cerium, praseodymium, samarium, erbium, aluminum, chlorine, and fluorine, and
wherein the second luminescence center element is different from the first luminescence center element.

27. The light-emitting element according to claim 22, wherein the light-emitting material comprises a host material doped with the first luminescence center element.

28. The light-emitting element according to claim 27,
wherein the host material is at least one selected from the group consisting of zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium-aluminum sulfide, calcium-gallium sulfide, strontium-gallium sulfide, and barium-gallium sulfide.

29. A light-emitting device includes the light-emitting element according to claim 22, further comprising a control means for controlling light emission of the light-emitting element.

30. An electronic device comprising the light-emitting element according to claim 22, further comprising a control means for controlling light emission of the light-emitting element.
